(19) United States
(12) Patent Application Publication
(10) Pub. No.: US 2026/0197758 A1
(43) Pub. Date: Jul. 9, 2026

(54) METHOD, DEVICE AND COMPUTER STORAGE MEDIUM OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 18/868,509

(22) PCT Filed: May 25, 2022
(86) PCT No.: PCT/CN2022/095019

§ 371 Date: Nov. 22, 2024

(51) Int. Cl. H04W 52/02; H04W 72/044

(52) U.S. Cl. CPC H04W 52/0235; H04W 72/044

(57) ABSTRACT

Embodiments of the present disclosure relate to methods, devices and computer readable media of communication. A network device transmits, a set of configurations for WUS monitoring of at least one set of terminal devices, a configuration in the set of configurations indicating a set of time-frequency resources unrelated to a PO; and performs a WUS transmission at least based on the set of time-frequency resources. A terminal device determines a configuration for WUS monitoring and determines a set of time-frequency resources unrelated to a PO to perform the WUS monitoring. In this way, unnecessary monitoring may be avoided and further power saving may be achieved.

### TECHNICAL FIELD

Embodiments of the present disclosure generally relate to the field of telecommunication, and in particular, to methods, devices and computer storage media of communication for wake-up signal (WUS) monitoring.

### BACKGROUND

Currently, it has been proposed to use main radio to describe a regular communication device performing normal radio resource control (RRC) states and additionally design a WUS receiver to monitor a WUS for turn-on of the main radio. When a terminal device is not receiving service, the terminal device may enter a low power (LP) WUS mode during which the main radio is switched off and the WUS receiver is switched on to monitor the WUS. However, the WUS is a common signal and it is impossible for a network to access a specific terminal device. Thus, if traffic is only for specific terminal devices, unnecessary WUS reception may happen for terminal devices other than the specific terminal devices.

### SUMMARY

In general, embodiments of the present disclosure provide methods, devices and computer storage media of communication for WUS monitoring.

In a first aspect, there is provided a method of communication. The method comprises: determining, at a terminal device, a configuration for wake-up signal monitoring; determining, at least based on the configuration, a set of time-frequency resources unrelated to a paging occasion; and performing the wake-up signal monitoring at least based on the set of time-frequency resources.

In a second aspect, there is provided a method of communication. The method comprises: transmitting, at a network device, a set of configurations for wake-up signal monitoring of at least one set of terminal devices, a configuration in the set of configurations indicating a set of time-frequency resources unrelated to a paging occasion; and performing a wake-up signal transmission at least based on the set of time-frequency resources.

In a third aspect, there is provided a terminal device. The terminal device comprises a processor configured to cause the terminal device to perform the method according to the first aspect of the present disclosure.

In a fourth aspect, there is provided a network device. The network device comprises a processor configured to cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates an example structure of a terminal device in which some embodiments of the present disclosure can be implemented;

FIG. 1C illustrates a diagram illustrating a LP WUS mechanism in which some embodiments of the present disclosure can be implemented;

FIG. 2 illustrates a schematic diagram illustrating a process of communication according to embodiments of the present disclosure;

FIG. 3A illustrates a schematic diagram of a time domain resource in which some embodiments of the present disclosure can be implemented;

FIG. 3B illustrates a schematic diagram of a frequency domain resource in which some embodiments of the present disclosure can be implemented;

FIG. 3C illustrates a schematic diagram of an on-duration timer in which some embodiments of the present disclosure can be implemented;

FIG. 3D illustrates a schematic diagram of a WUS monitoring occasion in which some embodiments of the present disclosure can be implemented;

FIG. 4A illustrates a schematic diagram of WUS monitoring based on an on/off keying (OOK) sequence in which some embodiments of the present disclosure can be implemented;

FIG. 4B illustrates a schematic diagram of a bitmap for an OOK sequence in which some embodiments of the present disclosure can be implemented;

FIG. 5 illustrates an example method of communication implemented at a terminal device in accordance with some embodiments of the present disclosure;

FIG. 6 illustrates an example method of communication implemented at a network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

In general, the fifth generation (5G) devices consume tens of milliwatts in RRC idle or inactive state and hundreds of milliwatts in RRC connected state. Designing to prolong battery life is a necessity for improving energy efficiency as well as for better user experience.

To meet the battery life requirements, an enhanced discontinuous reception (eDRX) cycle with a large value is expected to be used. The eDRX cycle may result in high latency and thus is not suitable for services with requirements of both long battery life and low latency. For example, in fire detection and extinguishment use case, a long eDRX cycle cannot meet the delay requirements. That is, eDRX is apparently not suitable for latency-critical use cases. Thus, it is expected to study an ultra-low power mechanism that can support low latency, e.g., lower than eDRX latency.

As mentioned above, a LP WUS mode is proposed during which main radio is switched off and a WUS receiver is switched on to monitor a WUS for turn-on of main radio. However, the WUS is a common signal and thus unnecessary WUS reception may happen if traffic is only for specific terminal devices.

In view of this, embodiments of the present disclosure provide a solution of communication for WUS monitoring of the WUS receiver. In the solution, a terminal device determines a configuration for WUS monitoring and determines a set of time-frequency resources unrelated to a paging occasion (PO) at least based on the configuration. Then the terminal device performs WUS monitoring at least based on the set of time-frequency resources. In this way, unnecessary monitoring may be avoided and further power saving may be achieved.

Principles and implementations of the present disclosure will be described in detail below with reference to the figures.

### Example of Communication Network

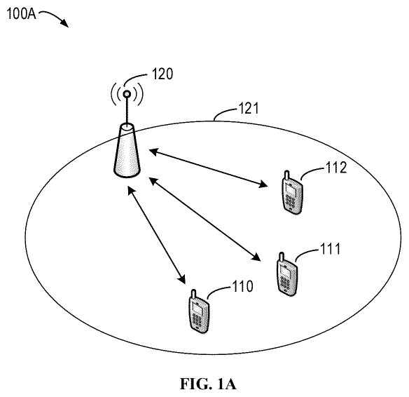

FIG. 1A illustrates a schematic diagram of an example communication network 100A in which some embodiments of the present disclosure can be implemented. As shown in FIG. 1A, the communication network 100A may include terminal devices 110, 111 and 112 and a network device 120. In some embodiments, the network device 120 may provide a serving cell (also referred to as a cell herein) 121 to serve one or more terminal devices. In this example, the terminal devices 110, 111 and 112 are shown as being located in the cell 121 and served by the network device 120.

It is to be understood that the number of devices or cells in FIG. 1A is given for the purpose of illustration without suggesting any limitations to the present disclosure. The communication network 100A may include any suitable number of network devices and/or terminal devices and/cells adapted for implementing implementations of the present disclosure.

As shown in FIG. 1A, each of the terminal devices 110, 111 and 112 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates a diagram 100B illustrating a terminal device in which some embodiments of the present disclosure can be implemented. For convenience, FIG. 1B is described in connection with the terminal device 110 of FIG. 1A. It is to be understood that the terminal device 111 and 112 may also have such structure 100B.

As shown in FIG. 1B, the terminal device 110 may comprise a WUS receiver 131 and main radio 132. The WUS receiver 131 is configured to monitor a WUS. The main radio 132 is configured as a regular communication device performing normal radio resource control (RRC) states.

In some embodiments, the WUS receiver 131 may detect the WUS indicating turn-off of the main radio 132, and trigger the main radio 132 to enter a turn-off or deep-sleep state. In the turn-off or deep-sleep state, the terminal device 110 is not required to process a RRC idle or inactive or connected state procedure. In some embodiments, the WUS receiver 131 may detect the WUS indicating turn-on of the main radio 132, and trigger the main radio 132 to enter a turn-on state. In the turn-on state, the main radio 132 may monitor POs. More details will be described in connection with FIG. 1C below.

FIG. 1C illustrates a diagram 100C illustrating a LP WUS mechanism in which some embodiments of the present disclosure can be implemented. For convenience, FIG. 1C is described in connection with FIG. 1B. As shown in FIG. 1C, when the terminal device 110 enters a LP WUS mode, the WUS receiver 131 may turn on and the main radio 132 may not monitor POs. When the WUS receiver 131 detects a WUS (for example, WUS=1) indicating turn-on of the main radio 132, the WUS receiver 131 triggers the main radio 132 to turn on and the WUS receiver 131 turns off. In this case, the main radio 132 may start monitoring POs 141.

Compared with an eDRX mechanism, a LP WUS mechanism may reduce both power consumption and latency. Although a WUS receiver is turned on in a LP WUS mode, power consumption in the LP WUS mode may be 100 times less than main radio as the WUS receiver only receive a simple signal (e.g., OOK).

However, a WUS in the LP WUS mechanism is a common signal. If traffic is only for specific terminal devices, unnecessary WUS reception may happen for terminal devices other than the specific terminal devices. With reference to FIG. 1A, it is assumed that the terminal devices 110, 111 and 112 enter a LP WUS mode to monitor a WUS. If traffic is only for the terminal device 110, the network device 120 may send a WUS in the cell 121 to find the terminal device 110. In conventional solution, the terminal devices 110, 111 and 112 will receive the WUS. In this case, the WUS is a useful signal for the terminal device 110, but the WUS is a useless signal for the terminal devices 111 and 112. This will cause unnecessary decoding of the WUS at the terminal devices 111 and 112 and will cause unnecessary power consumption for the terminal devices 111 and 112.

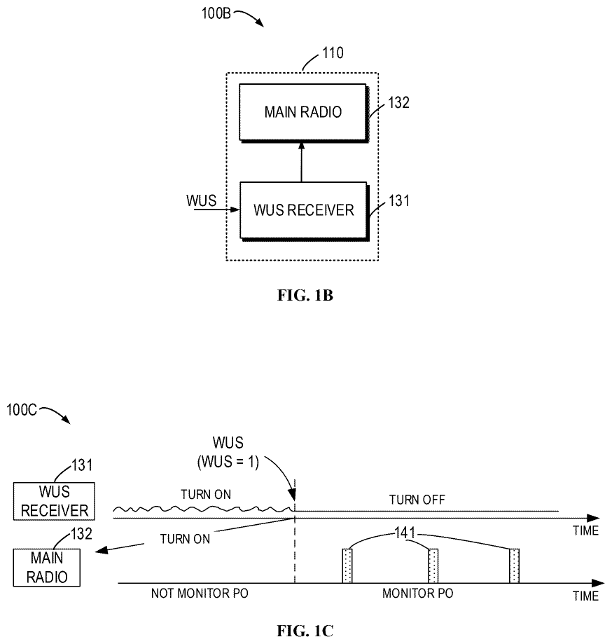

In view of this, embodiments of the present disclosure provide a solution for WUS monitoring in a LP WUS mode. The detailed description will be made with reference to FIGS. 2 to 5 below.

### Example Implementation of WUS Monitoring in LP WUS Mode

FIG. 2 illustrates a schematic diagram illustrating a process 200 of communication according to embodiments of the present disclosure. For the purpose of discussion, the process 200 will be described with reference to FIG. 1A. The process 200 may involve the terminal device 110 and the network device 120 as illustrated in FIG. 1A. It is to be understood that the steps and the order of the steps in FIG. 2 are merely for illustration, and not for limitation. For example, the order of the steps may be changed. Some of the steps may be omitted or any other suitable additional steps may be added.

As shown in FIG. 2, the network device 120 may transmit 210, to the terminal device 110, a set of configurations for WUS monitoring of at least one set of terminal devices (for example, the terminal devices 110, 111 and 112 in the cell 121). Each configuration in the set of configurations indicates a set of time-frequency resources unrelated to a PO. In some embodiments, the set of configurations may comprise multiple configurations, and the multiple configurations have respective indexes. In some embodiments, the set of configurations may comprise a single configuration.

In some embodiments, the network device 120 may transmit the set of configurations via broadcast. In some embodiments, the network device 120 may transmit the set of configurations via RRC signaling. In some embodiments, the set of configurations may be predefined and the network device 120 may not transmit the set of configurations.

The terminal device 110 may determine 220, from the set of configurations, a configuration for WUS monitoring. In some embodiments, the terminal device 110 may determine an index of the configuration in the set of configurations, and determine the configuration based on the index.

### Index Indicated by Network

In some embodiments, the terminal device 110 may receive the index from the network device 120 via a RRC signaling. For example, the terminal device 110 may receive the index via a RRCRelease message, a RRCSetup message, a RRCResume message, a RRCReconfiguration message or a RRCRestablishment message. It is to be understood that any other suitable ways are also feasible.

In some embodiments, the terminal device 110 may receive the index from a core network element (not shown) via a NAS signaling. For example, the terminal device 110 may receive the index via a Registration Accept message. In this way, the index may be assigned by a network.

### Index Calculated by Formula

In some embodiments, the terminal device 110 may determine the index based on an identity of the terminal device 110 and the number of configurations in the set of configurations. In some embodiments, the terminal device 110 may determine the index based on an equation (1) below.

$$I = {I}_{1} mod N \qquad ( 1 )$$

where I denotes the index of the configuration in the set of configurations, I₁ denotes an identity of the terminal device 110, and N denotes a total number of configurations in the set of configurations.

In some embodiments, the identity I₁ of the terminal device 110 may be obtained from equation (2) below.

$${I}_{1} = {I}_{2} \qquad ( 2 )$$

where I₁ denotes an identity of the terminal device 110, and I₂ denotes a 5G system temporary mobile subscriber identity (5G-S-TMSI) of the terminal device 110.

In some alternative embodiments, the identity I₁ of the terminal device 110 may be obtained from equation (3) below.

$${I}_{1} = {I}_{2} mod X \qquad ( 3 )$$

where I₁ denotes an identity of the terminal device 110, 12 denotes a 5G-S-TMSI of the terminal device 110, and X denotes a predefined positive integer. For example, X may be 256, 512, 1024, 2048, etc., It is to be understood that the equations (1) to (3) are merely examples, and any other suitable ways are also feasible.

In some embodiments where the terminal device 110 calculates a value of the index based on formula, the terminal device 110 may receive a value of the index from a network. In this case, the terminal device 110 may use the received value of the index to overwrite the calculated value of the index.

### Index Calculated Based on Formula and Paging Probability

In some embodiments, configurations in the set of configurations may be divided into groups based on paging probability (PP) which is a NAS assistance information. In some embodiments, a configuration in the set of configurations may comprise the number of configurations in each of the groups and at least one PP threshold. In some embodiments, the number of configurations in each of the groups and the at least one PP threshold may be configured or predefined. For example, a list of the divided groups may be as shown in Table 1.

TABLE 1

| Group | | Number of |
|---|---|---|
| Index | PP | Configurations |
| 1 | PP < threshold 1 | N1 |
| 2 | threshold 1 < PP ≤ threshold 2 | N2 |
| 3 | PP > threshold 2 | N3 |

It is to be understood that Table 1 is merely an example, and is not intended for limitation. Any other suitable grouping ways are also feasible.

In some embodiments, the terminal device 110 may determine one of the groups based on the at least one PP threshold. In some embodiments, if a PP is configured for the terminal device 110, the terminal device 110 may determine the one of the groups based on comparison between the PP configured for the terminal device 110 and the at least one PP threshold. For example, in the example of Table 1, if the PP configured for the terminal device 110 is smaller than threshold 1, the terminal device 110 may determine Group 1 as the one of the groups.

In some embodiments, if a PP is not configured for the terminal device 110, the terminal device 110 may determine a predetermined one of the groups as the one of the groups. For example, the predetermined group may be a group having the maximum group index. As another example, the predetermined group may be a group having the minimum group index. Of course, any other suitable ways are also feasible. For example, in the example of Table 1, if a PP is not configured for the terminal device 110, the terminal device 110 may determine Group 3 as the one of the groups.

In some embodiments, if the network device 120 does not provide the number of configurations in each of the groups or a PP threshold, the terminal device 110 may determine that only one group presents, that is, the set of configurations belongs to one group.

Then the terminal device 110 may determine an intermediary index based on the number of configurations in the determined group and based on an identity of the terminal device 110. For example, the intermediary index may be determined based on equation (6) below.

$${I}_{inter} = ID mod Nx \qquad ( 6 )$$

where Iᵢₙₜₑᵣ denotes the intermediary index, ID denotes an identity of the terminal device 110, and Nx denotes the number of configurations in the determined group. It is to be understood that equation (6) is merely for illustration, and is not for limitation. Any other suitable forms are also feasible.

Upon determination of the intermediary index, the terminal device 110 may determine whether at least one group in the groups has an index lower than an index of the one of the groups. If there is the at least one group, the terminal device 110 may determine the index based on the intermediary index and the number of configurations in the at least one group in the groups. If none of the groups has an index lower than an index of the one of the groups, the terminal device 110 may determine the index based on the intermediary index. For example, in the example of Table 1, the index of the configuration may be finally determined based on Table 2.

TABLE 2

| Index of Determined Group | Index of Configuration |
|---|---|
| 1 | intermediary index |
| 2 | intermediary index + N1 |
| 3 | intermediary index + N1 + N2 |

It is to be understood that Table 2 is merely an example, and is not intended for limitation. Any other suitable grouping ways are also feasible.

For illustration, an example will be described below. In this example, the network device 120 provides 7 configurations and provides two PP thresholds (for example, threshold 1 and threshold 2) and N1=2, N2=3, N3=2. Here, the number of PP thresholds implicitly indicates that the 7 configurations are divided into 3 groups. If threshold 1<PP≤threshold 2, the terminal device 110 may determine that the group index is 2 based on Table 1. If ID of the terminal device 110 is 16, the terminal device 110 may determine, based on the above equation (6), that an intermediary index is 1. As the group index is 2, the terminal device 110 may determine, based on Table 2, that the index of configuration=1+N1 (i.e., 2)=3.

Continue to refer to FIG. 2, upon determination the configuration for WUS monitoring, the terminal device 110 may determine 230 a set of time-frequency resources unrelated to a PO at least based on the configuration. In some embodiments, the terminal device 110 may determine time domain information and frequency domain information for the set of time-frequency resources.

### Time Domain Information

In some embodiments, if the configuration does not comprise time domain information, the terminal device 110 may determine that a WUS is monitored all the time.

In some embodiments, the terminal device 110 may receive, from the network device 120, an indication indicating whether a WUS is monitored all the time. If the indication indicates that the WUS is monitored all the time, the terminal device 110 may determine that the WUS is monitored all the time. If the indication indicates that the WUS is not monitored all the time, the terminal device 110 may determine that the WUS is monitored based on time domain information in the configuration.

In some embodiments, the configuration may comprise a period for a WUS transmission and a starting offset of the period and may also comprise information of a slot in which a WUS transmission window starts and duration of the WUS transmission window. For example, the network may provide the configuration as below:
Every item in the LP-WUS-ConfigGroupList may include RepetitionPeriodAndOffset, WindowStartSlot, WindowDuration.
RepetitionPeriodAndOffset: Provide cycle and offset for one LP WUS group in the list.
WindowStartSlot: Indicate the slot in which LP WUS transmission window starts.
WindowDuration: Indicate starting from the start slot, the duration in slot which LP WUS may be scheduled.

In some embodiments, the terminal device 110 may determine a set of system frame numbers (SFNs) based on the period and starting offset. For example, the terminal device 110 may determine the set of SFNs based on equation (4) below.

$$SFN mod Repetition Period = Offset \qquad ( 4 )$$

where SFN denotes a SFN, Repetition Period denotes the period, and Offset denotes the starting offset.

Then the terminal device 110 may determine time-domain information of the set of time-frequency resources based on the determined set of SFNs and the information of the slot and the duration. For example, the terminal device 110 may determine a starting slot of a WUS monitoring window in a determined SFN based on the window start slot, and then determine the WUS monitoring window based on the starting slot and window duration.

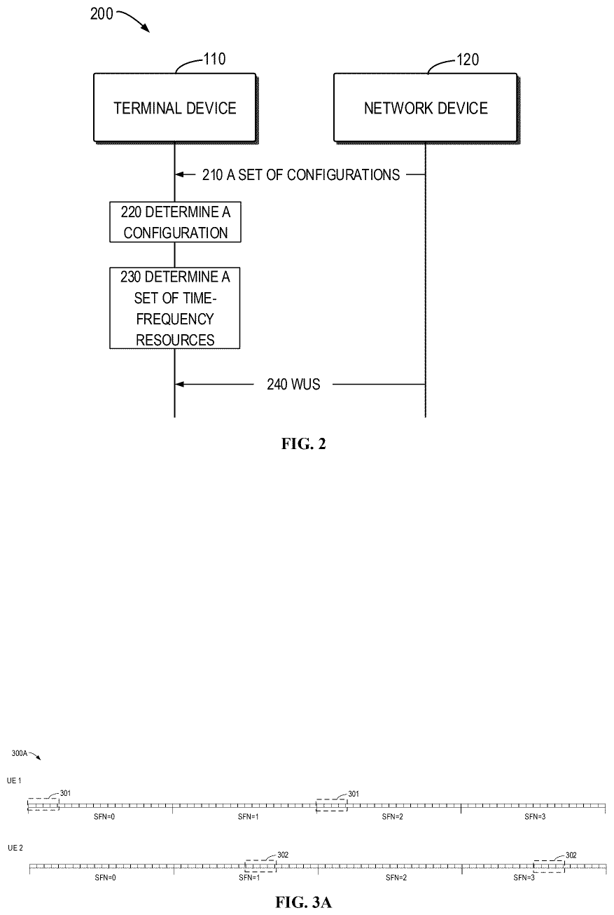

For illustration, an example will be described with reference to FIG. 3A. FIG. 3A illustrates a schematic diagram 300A of a time domain resource in which some embodiments of the present disclosure can be implemented. In this example, a configuration with index 0 may comprise: Repetition Period=2 (SFN), Offset=0 (SFN), window start slot=0 (slot), and window duration=4 (slot). A configuration with index 1 may comprise: Repetition Period=2 (SFN), Offset=1 (SFN), window start slot=10 (slot), and window duration=4 (slot). It is assumed that subcarrier spacing (SCS)=30 kHz, i.e., 1 subframe=2 slot. It is also assumed that the terminal device 110 uses the configuration with index 0 and the terminal device 111 uses the configuration with index 1.

SFN of a radio frame in which a WUS is scheduled may be determined based on the above equation (4). One or more slots within the scheduled SFN may be determined based on the window start slot and window duration. As shown in FIG. 3A, UE1 may determine WUS windows 301 as time-frequency resources for WUS monitoring. UE2 may determine WUS windows 302 as time-frequency resources for WUS monitoring.

It is to be understood that FIG. 3A is merely an example, and is not intended for limitation. Any other suitable units such as frame, subframe or slot are also feasible.

In this way, using time domain resources may differentiate terminal devices in a group of terminal devices for WUS monitoring. That is, a WUS may be transmitted only for one or more specific terminal devices and thus unnecessary WUS reception may be avoided.

### Frequency Domain Information

In some embodiments, if the configuration does not comprise frequency domain information, the terminal device 110 may determine that a WUS is monitored on a predetermined bandwidth part (BWP).

In some embodiments, the configuration may comprise a frequency domain location and bandwidth of a WUS transmission indicated by a resource indicator value (RIV). For example, the network may provide the configuration as below:
Every item in the LP-WUS-ConfigGroupList may include RepetitionPeriodAndOffset, WindowStartSlot, WindowDuration, location AndBandwidth.
RepetitionPeriodAndOffset: Provide cycle and offset for one of LP WUS group in the list.
WindowStartSlot: Indicate the slot in which LP WUS transmission window starts.
WindowDuration: Indicate starting from the start slot, the duration in slot which LP WUS may be scheduled.
locationAndBandwidth: Indicate frequency domain location and bandwidth of LP WUS reception by UE.

In some embodiments, the terminal device 110 may determine frequency-domain information of the set of time-frequency resources based on the RIV. For illustration, an example will be described with reference to FIG. 3B.

FIG. 3B illustrates a schematic diagram 300B of a frequency domain resource in which some embodiments of the present disclosure can be implemented. In this example, each configuration in the set of configurations may comprise time domain information: Repetition Period=2 (SFN), Offset=0 (SFN), window start slot=0 (slot), and window duration=4 (slot). A configuration with index 0 may comprise: Location and Bandwidth=RIV 1 (e.g., 27xxx). A configuration with index 1 may comprise: Location and Bandwidth=RIV 2 (e.g., 26xxx). It is assumed that subcarrier spacing (SCS)=30 kHz, i.e., 1 subframe=2 slot. It is also assumed that the terminal device 110 uses the configuration with index 0 and the terminal device 111 uses the configuration with index 1.

SFN of a radio frame in which a WUS is scheduled may be determined based on the above equation (4). One or more slots within the scheduled SFN may be determined based on the window start slot and window duration. As shown in FIG. 3B, UE 1 may determine WUS windows 311 and Band 1 as time-frequency resources for WUS monitoring. UE 2 may determine WUS windows 311 and Band 2 as time-frequency resources for WUS monitoring.

It is to be understood that FIG. 3B is merely an example, and is not intended for limitation. Any other suitable units such as frame, subframe or slot are also feasible.

In this way, using frequency domain resources may differentiate terminal devices in a group of terminal devices for WUS monitoring. That is, a WUS may be transmitted only for one or more specific terminal devices and thus unnecessary WUS reception may be avoided.

### Time-Frequency Domain Information

It is to be understood that the time domain information and the frequency domain information may be used in combination, i.e., time-frequency domain information, to differentiate terminal devices in a group of terminal devices for WUS monitoring.

In some embodiments, the configuration may comprise a period for a WUS transmission and a starting offset of the period and may also comprise information of a slot in which a WUS transmission window starts and duration of the WUS transmission window. Further, the configuration may comprise a frequency domain location and bandwidth of a WUS transmission indicated by a RIV. For example, the network may provide the configuration as below:
Every item in the LP-WUS-ConfigGroupList may include RepetitionPeriodAndOffset, WindowStartSlot, WindowDuration, location AndBandwidth.
RepetitionPeriodAndOffset: Provide cycle and offset for one of LP WUS group in the list.
WindowStartSlot: Indicate the slot in which LP WUS transmission window starts.
WindowDuration: Indicate starting from the start slot, the duration in slot which LP WUS may be scheduled.
locationAndBandwidth: Indicate frequency domain location and bandwidth of LP WUS reception by UE.

In some embodiments, the terminal device 110 may determine a set of SFNs based on the period and starting offset. Then the terminal device 110 may determine time-domain information of the set of time-frequency resources based on the determined set of SFNs and the information of the slot and the duration. Further, the terminal device 110 may determine frequency-domain information of the set of time-frequency resources based on the RIV.

In this way, using time and frequency domain resources may differentiate terminal devices in a group of terminal devices for WUS monitoring. A WUS may be transmitted only for one or more specific terminal devices and thus unnecessary WUS reception may be avoided.

Return to FIG. 2, upon determination of the set of time-frequency resources, the terminal device 110 may perform 240 WUS monitoring at least based on the set of time-frequency resources.

In some embodiments where at least one of time or frequency domain resources is used to differentiate terminal devices in a group of terminal devices for WUS monitoring, the terminal device 110 may perform the WUS monitoring based on the determined set of time-frequency resources.

### DRX-Alike Configuration

In some embodiments, the configuration may comprise a value of an on-duration timer, a slot offset before a starting of the on-duration timer, a period for a WUS transmission and a starting offset of the period. In this way, another method to describe time domain information in the set of time-frequency resources is provided.

In some embodiments, the on-duration timer may define duration at the beginning of a WUS monitoring cycle. In some embodiments, the on-duration timer may have a value in 1/32 ms or ms. In some embodiments, the starting offset of the period may have a value in ms. In some embodiments, the slot offset may define a delay before starting the on-duration timer. In some embodiments, the slot offset may have a value in 1/32 ms. For example, the network may provide the configuration as below:
onDurationTimer: The duration at the beginning of a LP-WUS monitoring cycle.
cycleAndStartOffset: Cycle provides the period and StartOffset defines the subframe where the cycle starts.
slotOffset: The delay before starting the onDurationTimer.

In some embodiments, the terminal device 110 may determine at least one pair of SFN and subframe number based on the period and the starting offset. For example, the terminal device 110 may determine a pair of SNF and subframe number based on equation (5) below.

$$[ ( SFN \times 10 ) + {N}_{subframe} ] mod ( Cycle ) = StartOffset \qquad ( 5 )$$

where SFN denotes a radio frame associated with a WUS transmission, N_{subframe} denotes subframe number associated with a WUS transmission, Cycle denotes a period for a WUS transmission, and StartOffset denotes a starting offset of the period. It is to be understood that this is merely an example, and any other suitable ways are also feasible.

Then the terminal device 110 may start the on-duration timer after the slot offset from beginning of a subframe indicated by the determined SFN and subframe number. During running of the on-duration timer, the terminal device 110 may perform the WUS monitoring during running of the on-duration timer.

For illustration, an example will be described with reference to FIG. 3C. FIG. 3C illustrates a schematic diagram 300C of an on-duration timer in which some embodiments of the present disclosure can be implemented. In this example, a configuration in the set of configurations may comprise time domain information: Cycle=40 ms, StartOffset=5 ms, SlotOffset=16 (i.e., 16/32 ms=0.5 ms), and on-duration timer=10 ms. Based on the above equation (5), it can be known that the WUS monitoring cycle may be started from 5 ms, 45 ms, 85 ms, etc., As shown in FIG. 3C, an on-duration timer (denoted as onDTimer) may be started at 0.5 ms after 5 ms, 45 ms, 85 ms, etc., When the on-duration timer starts, the terminal device 110 may perform the WUS monitoring.

It is to be understood that FIG. 3C is merely an example, and is not intended for limitation. Any other suitable units such as frame, subframe or slot are also feasible.

In this way, using time domain resources may differentiate terminal devices in a group of terminal devices for WUS monitoring. That is, a WUS may be transmitted only for one or more specific terminal devices and thus unnecessary WUS reception may be avoided.

### PO-Alike Configuration

In some embodiments, the set of configurations may comprise a single configuration for WUS monitoring of at least one set of terminal devices. The configuration may comprise a period for a WUS monitoring occasion and information of a starting symbol for the WUS monitoring. The terminal device 110 may determine a set of time-frequency resources based on the single configuration. For example, the network may provide the configuration as below:
lp-wusCycle: the cycle for LP-WUS monitoring occasion;
firstMonitoringOccasion: indicate the first symbol which UE monitors LP-WUS occasion within the calculated SFN.

In some embodiments, the terminal device 110 may determine, based on the period for the WUS monitoring occasion and an identity of the terminal device 110, a SFN of a radio frame in which WUS monitoring is performed. For example, the terminal device 110 may determine the SFN based on equation (7) below.

$$SFN mod lp - wusCycle = ID mod lp - wusCycle \qquad ( 7 )$$

where SFN denotes a radio frame in which WUS monitoring is performed, lp-wusCycle denotes a period for a WUS monitoring occasion, and ID denotes an identity of the terminal device 110. It is to be understood that the equation (7) is merely an example, and any other suitable ways are also feasible.

Then the terminal device 110 may perform the WUS monitoring in a symbol indicated by the information of the starting symbol within a frame corresponding to the determined SFN. The duration of the WUS monitoring may be based on a physical layer configuration.

For illustration, an example will be described with reference to FIG. 3D. FIG. 3D illustrates a schematic diagram 300D of a WUS monitoring occasion in which some embodiments of the present disclosure can be implemented. In this example, a period for a WUS monitoring occasion is 2 (radio frame), a starting symbol is 17 (symbol) and a duration is 4. It is assumed that SCS=30 kHz, i.e., 1 frame=10 subframe=20 slot=280 symbol. The duration is based on a physical layer configuration.

If ID of UE1=16, it may be determined from the equation (7) that SFN=0, 2, 4, 6, 8, etc., If ID of UE2=15, it may be determined from the equation (7) that SFN=1, 3, 5, 7, 9, etc., Then as shown in FIG. 3D, UE1 may monitor a WUS at WUS monitoring occasions 320, and UE2 may monitor a WUS at WUS monitoring occasions 321. This is merely an example, and is not intended for limitation.

In this way, WUS monitoring occasions are divided by time domain for terminal devices in a group of terminal devices for WUS monitoring. Granularity of one WUS corresponding to terminal devices may be reduced, and unnecessary signal reception may be avoided and further power saving may be achieved.

### Sequence Pattern

In some embodiments, the network may design multiple sequences (also referred to as WUS sequences, e.g., OOK sequences) of a WUS for different groups of terminal devices. In some embodiments, one (for convenience, also referred to as a second sequence herein) of the multiple sequences corresponds to multiple groups of terminal devices comprising the terminal device 110, and each (for convenience, also referred to as a first sequence herein) of other ones of the multiple sequences corresponds to one group of terminal devices.

As long as more than one group needs to be indicated, a network may transmit the second sequence for the multiple groups of terminal devices. In some embodiments, the multiple groups of terminal devices may comprise all terminal devices. Only when the network wants to indicate a specific group, the network may transmit a first sequence corresponding to the specific group.

In some embodiments, the network device 120 may provide a mapping relationship between a sequence of a WUS and one or multiple groups of terminal devices. In some embodiments, the network device 120 may provide the first and second sequences in the configuration for WUS monitoring.

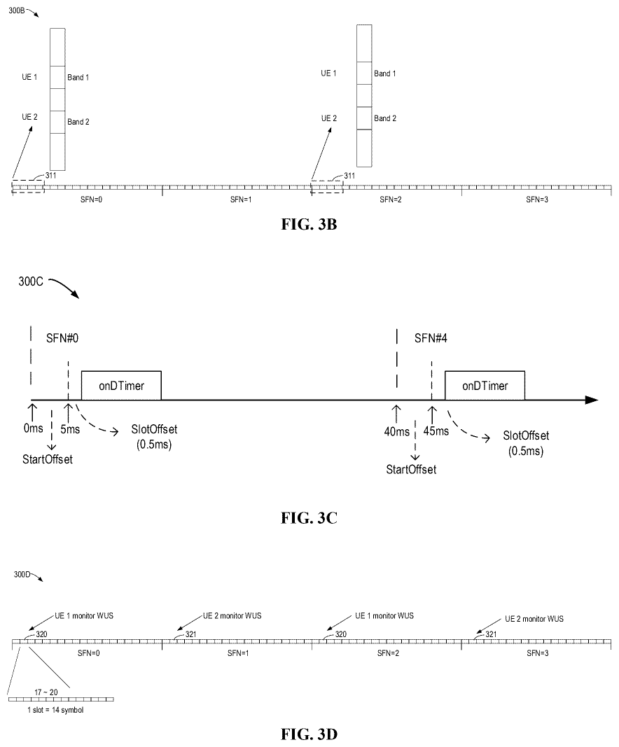

FIG. 4A illustrates a schematic diagram 400A of WUS monitoring based on an OOK sequence in which some embodiments of the present disclosure can be implemented. As shown by a mapping relationship 401 in FIG. 4A, sequence OOK 1 may correspond to a common group comprising Group 1, Group 2 and Group 3. Sequence OOK2 may correspond to Group 1. Sequence OOK3 may correspond to Group 2. Sequence OOK4 may correspond to Group 3. The Group 1 comprises UE1 and UE2, Group 2 comprises UE3, and Group 3 comprises UE4.

In case 1 as shown in FIG. 4A, as to traffic for UE1 and UE2, a network may send OOK2 directed to UE1 and UE2 to find UE1 and UE2. In case 2 as shown in FIG. 4A, as to traffic for UE1 and UE4, a network may send OOK1 directed to all UEs to find UE1 and UE4. It is to be understood that FIG. 4A is merely an example, and is not intended for limitation.

In some embodiments, upon determination of a set of time-frequency resources based on a configuration for WUS monitoring, if a sequence detected on the determined set of time-frequency resources corresponds to the first sequence or the second sequence, the terminal device 110 may perform a paging monitoring. That is, the terminal device 110 is required to process an idle or inactive procedure.

In some embodiments, if a sequence detected on the determined set of time-frequency resources does not correspond to the first sequence or the second sequence, the terminal device 110 may not perform a paging monitoring. That is, the terminal device 110 is not required to process an idle or inactive procedure.

In this way, granularity of one WUS corresponding to terminal devices may also be reduced, and unnecessary signal reception may be avoided and further power saving may also be achieved.

### Sequence Pattern and Bitmap

In some embodiments, the network may design multiple sequences (also referred to as WUS sequences, e.g., OOK sequences) of a WUS for different groups of terminal devices, and the multiple sequences may correspond to respective bit sequences. A bit location in each bit sequence may correspond to a group of terminal devices, and another bit location in each bit sequence may correspond to another group of terminal devices. For example, a bit sequence has M bits, and the number of WUS sequences equals to 2M, where M is a positive integer.

In some embodiments, the network may provide, to the terminal device 110, a mapping relationship between WUS sequences and bit sequences. FIG. 4B illustrates a schematic diagram 400B of a bitmap for an OOK sequence in which some embodiments of the present disclosure can be implemented. As shown in FIG. 4B, sequence OOK 1 may correspond to 000. Sequence OOK 2 may correspond to 001. Sequence OOK 3 may correspond to 010. Sequence OOK 4 may correspond to 011. Sequence OOK 5 may correspond to 100. Sequence OOK 6 may correspond to 101. Sequence OOK 7 may correspond to 110. Sequence OOK 8 may correspond to 111.

In some embodiments, upon determination of a set of time-frequency resources based on a configuration for WUS monitoring, if a sequence detected on the set of time-frequency resources corresponds to one of the multiple sequences, the terminal device 110 may determine a bit sequence corresponding to the detected sequence based on the mapping relationship. If a bit in a bit location corresponding to a group of terminal devices comprising the terminal device 110 has a first value (e.g., 1), the terminal device 110 may perform a paging monitoring. That is, the terminal device 110 is required to process an idle or inactive procedure. If the bit has a second value (e.g., 0) different from the first value, the terminal device 110 may not performing a paging monitoring. That is, the terminal device 110 is not required to process an idle or inactive procedure.

For example, in the example of FIG. 4B, a bit sequence has three bits. It is assumed that a first group of terminal devices corresponds to a lower bit location, a second group of terminal devices corresponds to a middle bit location, and a third group of terminal devices corresponds to a higher bit location. It is also assumed that the terminal device 110 is in the first group of terminal devices. In this case, if the terminal device 110 detects OOK2, OOK4, OOK6 or OOK8, the terminal device 110 may perform a paging monitoring. Otherwise, the terminal device 110 may not perform a paging monitoring.

It is to be understood that FIG. 4B is merely an example and is not intended for limitation.

In this way, granularity of one WUS corresponding to terminal devices may also be reduced, and unnecessary signal reception may be avoided and further power saving may also be achieved.

### Example Implementation of Methods

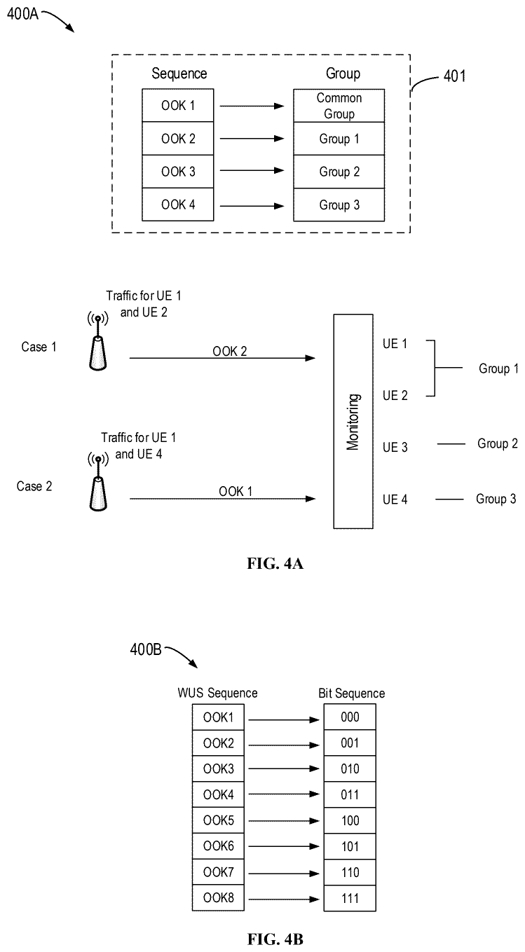

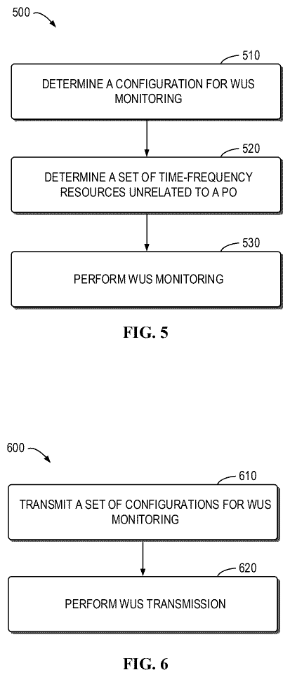

Corresponding to the above process, embodiments of the present disclosure provide methods of communication implemented at a terminal device and a network device. These methods will be described below with reference to FIGS. 5 and 6.

FIG. 5 illustrates an example method 500 of communication implemented at a terminal device in accordance with some embodiments of the present disclosure. For example, the method 500 may be performed at the terminal device 110 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 110 determines a configuration for wake-up signal monitoring.

In some embodiments, the terminal device 110 may receive a set of configurations for wake-up signal monitoring of at least one set of terminal devices, and determine an index of the configuration in the set of configurations.

In some embodiments, the terminal device 110 may receive the index via a radio resource control signaling or a non-access stratum signaling. In some embodiments, the terminal device 110 may determine the index based on an identity of the terminal device 110 and the number of configurations in the set of configurations.

At block 520, the terminal device 110 determines, at least based on the configuration, a set of time-frequency resources unrelated to a paging occasion.

In some embodiments, if the configuration does not comprise time domain information, the terminal device 110 may determine that a wake-up signal is monitored all the time. In some embodiments, if the configuration does not comprise frequency domain information, the terminal device 110 may determine that a wake-up signal is monitored on a predetermined bandwidth part.

In some embodiments, the terminal device 110 may receive an indication indicating whether a wake-up signal is monitored all the time. If the indication indicates that the wake-up signal is monitored all the time, the terminal device 110 may determine that the wake-up signal is monitored all the time. If the indication indicates that the wake-up signal is not monitored all the time, the terminal device 110 may determine that the wake-up signal is monitored based on time domain information in the configuration.

In some embodiments, the configuration comprises a period for a wake-up signal transmission and a starting offset of the period and information of a slot in which a wake-up signal transmission window starts and duration of the wake-up signal transmission window. In these embodiments, the terminal device 110 may determine a set of system frame numbers based on the period and starting offset, and determine time-domain information of the set of time-frequency resources based on the set of system frame numbers and the information of the slot and the duration.

In some embodiments, the configuration comprises a frequency domain location and bandwidth of a wake-up signal transmission indicated by a resource indicator value.

In these embodiments, the terminal device 110 may determine frequency-domain information of the set of time-frequency resources based on the resource indicator value.

At block 530, the terminal device 110 performs the wake-up signal monitoring at least based on the set of time-frequency resources.

In some embodiments, the configuration comprises a value of an on-duration timer, a slot offset before a starting of the on-duration timer, a period for a wake-up signal transmission and a starting offset of the period. In these embodiments, the terminal device 110 may determine at least one pair of system frame number and subframe number based on the period and the starting offset, and start the on-duration timer after the slot offset from beginning of a subframe. The terminal device 110 may perform the wake-up signal monitoring during running of the on-duration timer.

In some embodiments, the set of configurations is divided into groups and the configuration comprises the number of configurations in each of the groups and at least one paging probability threshold. In these embodiments, the terminal device 110 may determine one of the groups based on the at least one paging probability threshold. In some embodiments, if a paging probability is configured for the terminal device 110, the terminal device 110 may determine the one of the groups based on comparison between the paging probability configured for the terminal device and the at least one paging probability threshold. In some embodiments, if no paging probability is configured for the terminal device, the terminal device 110 may determine a predetermined one of the groups as the one of the groups.

Upon determination the one of the groups, the terminal device 110 may determine an intermediary index based on the number of configurations in the one of the groups and based on an identity of the terminal device. If at least one group in the groups has an index lower than an index of the one of the groups, the terminal device 110 may determine the index based on the intermediary index and the number of configurations in the at least one group in the groups. If none of the groups has an index lower than an index of the one of the groups, the terminal device 110 may determine the index based on the intermediary index.

In some embodiments, the terminal device 110 may receive the configuration for wake-up signal monitoring of at least one set of terminal devices, the configuration comprising a period for a wake-up signal monitoring occasion and information of a starting symbol for the wake-up signal monitoring. In these embodiments, the terminal device 110 may determine a system frame number based on the period for the wake-up signal monitoring occasion and an identity of the terminal device and perform the wake-up signal monitoring in a symbol indicated by the information of the starting symbol within a frame corresponding to the system frame number.

In some embodiments, the configuration comprises a first sequence of a wake-up signal corresponding to a group of terminal devices and a second sequence of a wake-up signal corresponding to multiple groups of terminal devices. In these embodiments, if a sequence detected on the set of time-frequency resources corresponds to the first sequence or the second sequence, the terminal device 110 may perform a paging monitoring. If a sequence detected on the set of time-frequency resources does not correspond to the first sequence or the second sequence, the terminal device 110 may perform no paging monitoring.

In some embodiments, the configuration comprises a sequence of a wake-up signal corresponding to a bit sequence and a bit location in the bit sequence corresponds to a group of terminal devices comprising the terminal device. In these embodiments, if a sequence detected on the set of time-frequency resources corresponds to the sequence of the wake-up signal and a bit in the bit location has a first value, the terminal device 110 may perform a paging monitoring. If a sequence detected on the set of time-frequency resources corresponds to the sequence of the wake-up signal and a bit in the bit location has a second value, the terminal device 110 may perform no paging monitoring.

With the method 500, unnecessary monitoring may be avoided and further power saving may be achieved.

FIG. 6 illustrates an example method 600 of communication implemented at a network device in accordance with some embodiments of the present disclosure. For example, the method 600 may be performed at the network device 120 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the network device 120 transmits a set of configurations for wake-up signal monitoring of at least one set of terminal devices, a configuration in the set of configurations indicating a set of time-frequency resources unrelated to a paging occasion.

At block 620, the network device 120 performs a wake-up signal transmission at least based on the set of time-frequency resources.

In some embodiments, the network device 120 may determine an index of the configuration in the set of configurations based on an identity of the terminal device and the number of configurations in the set of configurations, and transmit the index via a radio resource control signaling.

In some embodiments, if a wake-up signal is transmitted all the time, the network device 120 may cause no time domain information to be comprised in the configuration.

In some embodiments, if a wake-up signal is transmitted on a predetermined bandwidth part, the network device 120 may cause no frequency domain information to be comprised in the configuration.

In some embodiments, the network device 120 may transmit an indication indicating whether a wake-up signal is monitored all the time.

In some embodiments, the configuration comprises a period for a wake-up signal transmission and a starting offset of the period and information of a slot in which a wake-up signal transmission window starts and duration of the wake-up signal transmission window.

In some embodiments, the configuration comprises a frequency domain location and bandwidth of a wake-up signal transmission indicated by a resource indicator value.

In some embodiments, the configuration comprises a value of an on-duration timer, a slot offset before a starting of the on-duration timer, a period for a wake-up signal transmission and a starting offset of the period.

In some embodiments, the set of configurations is divided into groups and the configuration comprises the number of configurations in each of the groups and at least one paging probability threshold.

In some embodiments, the set of configurations comprises a single configuration for wake-up signal monitoring of at least one set of terminal devices, the single configuration comprising a period for a wake-up signal monitoring occasion and information of a starting symbol for the wake-up signal monitoring.

In some embodiments, the configuration comprises a first sequence of a wake-up signal corresponding to a group of terminal devices and a second sequence of a wake-up signal corresponding to multiple groups of terminal devices.

In some embodiments, the configuration comprises a sequence of a wake-up signal corresponding to a bit sequence and a bit location in the bit sequence corresponds to a group of terminal devices comprising the terminal device.

With the method 600, a configuration for WUS monitoring is designed to reduce unnecessary WUS transmission and achieve further power saving.

### Example Implementation of Device and Apparatus

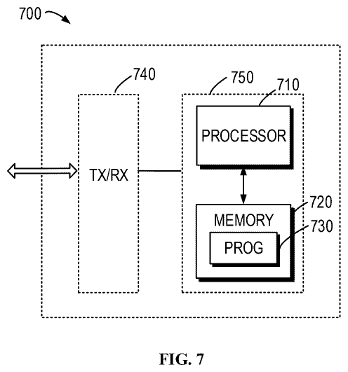

FIG. 7 is a simplified block diagram of a device 700 that is suitable for implementing embodiments of the present disclosure. The device 700 can be considered as a further example implementation of the terminal device 110 or the network device 120 as shown in FIG. 1A. Accordingly, the device 700 can be implemented at or as at least a part of the terminal device 110 or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1A to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a terminal device comprises a circuitry configured to: determine, at a terminal device, a configuration for wake-up signal monitoring; determine, at least based on the configuration, a set of time-frequency resources unrelated to a paging occasion; and perform the wake-up signal monitoring at least based on the set of time-frequency resources.

In some embodiments, a network device comprises a circuitry configured to: transmit, at a network device, a set of configurations for wake-up signal monitoring of at least one set of terminal devices, a configuration in the set of configurations indicating a set of time-frequency resources unrelated to a paging occasion; and perform a wake-up signal transmission at least based on the set of time-frequency resources.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

Clause 1. A method of communication, comprising:
determining, at a terminal device, a configuration for wake-up signal monitoring;
determining, at least based on the configuration, a set of time-frequency resources unrelated to a paging occasion; and
performing the wake-up signal monitoring at least based on the set of time-frequency resources.

Clause 2. The method of Clause 1, wherein determining the configuration comprises:
receiving a set of configurations for wake-up signal monitoring of at least one set of terminal devices; and
determining an index of the configuration in the set of configurations.

Clause 3. The method of Clause 2, wherein determining the index comprises at least one of the following:
receiving the index via a radio resource control signaling or a non-access stratum signaling; or
determining the index based on an identity of the terminal device and the number of configurations in the set of configurations.

Clause 4. The method of Clause 1, wherein determining the set of time-frequency resources comprises at least one of the following:
in accordance with a determination that the configuration does not comprise time domain information, determining that a wake-up signal is monitored all the time; or
in accordance with a determination that the configuration does not comprise frequency domain information, determining that a wake-up signal is monitored on a predetermined bandwidth part.

Clause 5. The method of Clause 1, wherein determining the set of time-frequency resources comprises:
receiving an indication indicating whether a wake-up signal is monitored all the time;
in accordance with a determination that the indication indicates that the wake-up signal is monitored all the time, determining that the wake-up signal is monitored all the time; and
in accordance with a determination that the indication indicates that the wake-up signal is not monitored all the time, determining that the wake-up signal is monitored based on time domain information in the configuration.

Clause 6. The method of Clause 1, wherein the configuration comprises a period for a wake-up signal transmission and a starting offset of the period and information of a slot in which a wake-up signal transmission window starts and duration of the wake-up signal transmission window, and wherein determining the set of time-frequency resources comprises:
determining a set of system frame numbers based on the period and starting offset; and
determining time-domain information of the set of time-frequency resources based on the set of system frame numbers and the information of the slot and the duration.

Clause 7. The method of Clause 1 or 6, wherein the configuration comprises a frequency domain location and bandwidth of a wake-up signal transmission indicated by a resource indicator value, and wherein determining the set of time-frequency resources comprises:
determining frequency-domain information of the set of time-frequency resources based on the resource indicator value.

Clause 8. The method of Clause 1, wherein the configuration comprises a value of an on-duration timer, a slot offset before a starting of the on-duration timer, a period for a wake-up signal transmission and a starting offset of the period,
wherein determining the set of time-frequency resources comprises: determining at least one pair of system frame number and subframe number based on the period and the starting offset; and starting the on-duration timer after the slot offset from beginning of a subframe, and
wherein performing the wake-up signal monitoring comprises performing the wake-up signal monitoring during running of the on-duration timer.

Clause 9. The method of Clause 2, wherein the set of configurations is divided into groups and the configuration comprises the number of configurations in each of the groups and at least one paging probability threshold, and wherein determining the index comprises:
determining one of the groups based on the at least one paging probability threshold;
determining an intermediary index based on the number of configurations in the one of the groups and based on an identity of the terminal device;
in accordance with a determination that at least one group in the groups has an index lower than an index of the one of the groups, determining the index based on the intermediary index and the number of configurations in the at least one group in the groups; and
in accordance with a determination that none of the groups has an index lower than an index of the one of the groups, determining the index based on the intermediary index.

Clause 10. The method of Clause 9, wherein determining the one of the groups comprises:
in accordance with a determination that a paging probability is configured for the terminal device, determining the one of the groups based on comparison between the paging probability configured for the terminal device and the at least one paging probability threshold; or
in accordance with a determination that no paging probability is configured for the terminal device, determining a predetermined one of the groups as the one of the groups.

Clause 11. The method of Clause 1, wherein determining the configuration comprises receiving the configuration for wake-up signal monitoring of at least one set of terminal devices, the configuration comprising a period for a wake-up signal monitoring occasion and information of a starting symbol for the wake-up signal monitoring,
wherein determining the set of time-frequency resources comprises determining a system frame number based on the period for the wake-up signal monitoring occasion and an identity of the terminal device, and
wherein performing the wake-up signal monitoring comprises performing the wake-up signal monitoring in a symbol indicated by the information of the starting symbol within a frame corresponding to the system frame number.

Clause 12. The method of Clause 1, wherein the configuration comprises a first sequence of a wake-up signal corresponding to a group of terminal devices and a second sequence of a wake-up signal corresponding to multiple groups of terminal devices, and wherein performing the wake-up signal monitoring comprises:
in accordance with a determination that a sequence detected on the set of time-frequency resources corresponds to the first sequence or the second sequence, performing a paging monitoring; or
in accordance with a determination that a sequence detected on the set of time-frequency resources does not correspond to the first sequence or the second sequence, performing no paging monitoring.

Clause 13. The method of Clause 1, wherein the configuration comprises a sequence of a wake-up signal corresponding to a bit sequence and a bit location in the bit sequence corresponds to a group of terminal devices comprising the terminal device, wherein performing the wake-up signal monitoring comprises:
in accordance with a determination that a sequence detected on the set of time-frequency resources corresponds to the sequence of the wake-up signal and a bit in the bit location has a first value, performing a paging monitoring; or
in accordance with a determination that a sequence detected on the set of time-frequency resources corresponds to the sequence of the wake-up signal and a bit in the bit location has a second value, performing no paging monitoring.

Clause 14. A method of communication, comprising:
transmitting, at a network device, a set of configurations for wake-up signal monitoring of at least one set of terminal devices, a configuration in the set of configurations indicating a set of time-frequency resources unrelated to a paging occasion; and
performing a wake-up signal transmission at least based on the set of time-frequency resources.

Clause 15. The method of Clause 14, further comprising:
determining an index of the configuration in the set of configurations based on an identity of the terminal device and the number of configurations in the set of configurations; and
transmitting the index via a radio resource control signaling.

Clause 16. The method of Clause 14, wherein transmitting the set of configurations comprises at least one of the following:
in accordance with a determination that a wake-up signal is transmitted all the time, causing no time domain information to be comprised in the configuration; or
in accordance with a determination that a wake-up signal is transmitted on a predetermined bandwidth part, causing no frequency domain information to be comprised in the configuration.

Clause 17. The method of Clause 14, further comprising:
transmitting an indication indicating whether a wake-up signal is monitored all the time.

Clause 18. The method of Clause 14, wherein the configuration comprises a period for a wake-up signal transmission and a starting offset of the period and information of a slot in which a wake-up signal transmission window starts and duration of the wake-up signal transmission window.

Clause 19. The method of Clause 14 or 18, wherein the configuration comprises a frequency domain location and bandwidth of a wake-up signal transmission indicated by a resource indicator value.

Clause 20. The method of Clause 14, wherein the configuration comprises a value of an on-duration timer, a slot offset before a starting of the on-duration timer, a period for a wake-up signal transmission and a starting offset of the period.

Clause 21. The method of Clause 14, wherein the set of configurations is divided into groups and the configuration comprises the number of configurations in each of the groups and at least one paging probability threshold.

Clause 22. The method of Clause 14, wherein the set of configurations comprises a single configuration for wake-up signal monitoring of at least one set of terminal devices, the single configuration comprising a period for a wake-up signal monitoring occasion and information of a starting symbol for the wake-up signal monitoring.

Clause 23. The method of Clause 14, wherein the configuration comprises a first sequence of a wake-up signal corresponding to a group of terminal devices and a second sequence of a wake-up signal corresponding to multiple groups of terminal devices.

Clause 24. The method of Clause 14, wherein the configuration comprises a sequence of a wake-up signal corresponding to a bit sequence and a bit location in the bit sequence corresponds to a group of terminal devices comprising the terminal device.

Clause 25. A terminal device comprising:
a processor configured to cause the terminal device to perform the method according to any of Clauses 1 to 13.

Clause 26. A network device comprising:
a processor configured to cause the network device perform the method according to any of Clauses 14 to 24.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device, a configuration for wake-up signal monitoring;
determining, at least based on the configuration, a set of time-frequency resources unrelated to a paging occasion; and
performing the wake-up signal monitoring at least based on the set of time-frequency resources.

2. The method of claim 1, wherein determining the configuration comprises:
receiving a set of configurations for wake-up signal monitoring of at least one set of terminal devices; and
determining an index of the configuration in the set of configurations.

3. The method of claim 2, wherein determining the index comprises at least one of the following:
receiving the index via a radio resource control signaling or a non-access stratum signaling; or
determining the index based on an identity of the terminal device and the number of configurations in the set of configurations.

4. The method of claim 1, wherein determining the set of time-frequency resources comprises at least one of the following:
in accordance with a determination that the configuration does not comprise time domain information, determining that a wake-up signal is monitored all the time; or
in accordance with a determination that the configuration does not comprise frequency domain information, determining that a wake-up signal is monitored on a predetermined bandwidth part.

5. The method of claim 1, wherein determining the set of time-frequency resources comprises:
receiving an indication indicating whether a wake-up signal is monitored all the time;
in accordance with a determination that the indication indicates that the wake-up signal is monitored all the time, determining that the wake-up signal is monitored all the time; and
in accordance with a determination that the indication indicates that the wake-up signal is not monitored all the time, determining that the wake-up signal is monitored based on time domain information in the configuration.

6. The method of claim 1, wherein the configuration comprises a period for a wake-up signal transmission and a starting offset of the period and information of a slot in which a wake-up signal transmission window starts and duration of the wake-up signal transmission window, and wherein determining the set of time-frequency resources comprises:
determining a set of system frame numbers based on the period and starting offset; and
determining time-domain information of the set of time-frequency resources based on the set of system frame numbers and the information of the slot and the duration.

7. The method of claim 1 or 6, wherein the configuration comprises a frequency domain location and bandwidth of a wake-up signal transmission indicated by a resource indicator value, and wherein determining the set of time-frequency resources comprises:
determining frequency-domain information of the set of time-frequency resources based on the resource indicator value.

8. The method of claim 1, wherein the configuration comprises a value of an on-duration timer, a slot offset before a starting of the on-duration timer, a period for a wake-up signal transmission and a starting offset of the period,
wherein determining the set of time-frequency resources comprises: determining at least one pair of system frame number and subframe number based on the period and the starting offset; and starting the on-duration timer after the slot offset from beginning of a subframe, and
wherein performing the wake-up signal monitoring comprises performing the wake-up signal monitoring during running of the on-duration timer.

9. The method of claim 2, wherein the set of configurations is divided into groups and the configuration comprises the number of configurations in each of the groups and at least one paging probability threshold, and wherein determining the index comprises:
determining one of the groups based on the at least one paging probability threshold;
determining an intermediary index based on the number of configurations in the one of the groups and based on an identity of the terminal device;
in accordance with a determination that at least one group in the groups has an index lower than an index of the one of the groups, determining the index based on the intermediary index and the number of configurations in the at least one group in the groups; and
in accordance with a determination that none of the groups has an index lower than an index of the one of the groups, determining the index based on the intermediary index.

10. The method of claim 9, wherein determining the one of the groups comprises:
in accordance with a determination that a paging probability is configured for the terminal device, determining the one of the groups based on comparison between the paging probability configured for the terminal device and the at least one paging probability threshold; or
in accordance with a determination that no paging probability is configured for the terminal device, determining a predetermined one of the groups as the one of the groups.

11. The method of claim 1, wherein determining the configuration comprises receiving the configuration for wake-up signal monitoring of at least one set of terminal devices, the configuration comprising a period for a wake-up signal monitoring occasion and information of a starting symbol for the wake-up signal monitoring,
wherein determining the set of time-frequency resources comprises determining a system frame number based on the period for the wake-up signal monitoring occasion and an identity of the terminal device, and
wherein performing the wake-up signal monitoring comprises performing the wake-up signal monitoring in a symbol indicated by the information of the starting symbol within a frame corresponding to the system frame number.

12. The method of claim 1, wherein the configuration comprises a first sequence of a wake-up signal corresponding to a group of terminal devices and a second sequence of a wake-up signal corresponding to multiple groups of terminal devices, and wherein performing the wake-up signal monitoring comprises:
in accordance with a determination that a sequence detected on the set of time-frequency resources corresponds to the first sequence or the second sequence, performing a paging monitoring; or
in accordance with a determination that a sequence detected on the set of time-frequency resources does not correspond to the first sequence or the second sequence, performing no paging monitoring.

13. The method of claim 1, wherein the configuration comprises a sequence of a wake-up signal corresponding to a bit sequence and a bit location in the bit sequence corresponds to a group of terminal devices comprising the terminal device, wherein performing the wake-up signal monitoring comprises:
in accordance with a determination that a sequence detected on the set of time-frequency resources corresponds to the sequence of the wake-up signal and a bit in the bit location has a first value, performing a paging monitoring; or
in accordance with a determination that a sequence detected on the set of time-frequency resources corresponds to the sequence of the wake-up signal and a bit in the bit location has a second value, performing no paging monitoring.

14. A method of communication, comprising:
transmitting, at a network device, a set of configurations for wake-up signal monitoring of at least one set of terminal devices, a configuration in the set of configurations indicating a set of time-frequency resources unrelated to a paging occasion; and
performing a wake-up signal transmission at least based on the set of time-frequency resources.

15. The method of claim 14, further comprising:
determining an index of the configuration in the set of configurations based on an identity of the terminal device and the number of configurations in the set of configurations; and
transmitting the index via a radio resource control signaling.

16. The method of claim 14, wherein transmitting the set of configurations comprises at least one of the following:
in accordance with a determination that a wake-up signal is transmitted all the time, causing no time domain information to be comprised in the configuration; or
in accordance with a determination that a wake-up signal is transmitted on a predetermined bandwidth part, causing no frequency domain information to be comprised in the configuration.

17. The method of claim 14, further comprising:
transmitting an indication indicating whether a wake-up signal is monitored all the time.

18. The method of claim 14, wherein the configuration comprises a period for a wake-up signal transmission and a starting offset of the period and information of a slot in which a wake-up signal transmission window starts and duration of the wake-up signal transmission window.

19. The method of claim 14 or 18, wherein the configuration comprises a frequency domain location and bandwidth of a wake-up signal transmission indicated by a resource indicator value.

20. A device of communication comprising:
a processor configured to cause the device to perform the method according to any of claims 1 to 13 or any of claims 14 to 19.
